(19) United States
(12) Patent Application Publication
(10) Pub. No.: US 2011/0302024 A1
(43) Pub. Date: Dec. 8, 2011

(54) EXTENDED CONVERSION TRACKING FOR OFFLINE COMMERCE

(75) Inventors: Asela Gunawardana, Seattle, WA (US); Sumit Basu, Seattle, WA (US); Christopher A. Meek, Kirkland, WA (US); Timothy Paek, Sammamish, WA (US); Matthew Uyttendaele, Seattle, WA (US)

(73) Assignee: Microsoft Corporation, Redmond, WA (US)

(21) Appl. No.: 12/793,685

(22) Filed: Jun. 4, 2010

(51) Int. Cl. G06Q 30/00

(52) U.S. Cl. 705/14.41

(57) ABSTRACT

In one embodiment, a physical world tracking mechanism may monitor the efficacy of an advertisement with an offline conversion component. A data storage device 306 may store a commercial location 110 described in the advertisement and associate a conversion action with the advertisement. A processor 304 may register the conversion action at the commercial location 110 executed by a handheld computing device 104 of a user.

### BACKGROUND

Traditional advertising may be sold on a pay-per-impression model, where the advertiser pays to have an advertisement shown to the audience. Typically, such advertising may be priced according to volume and targeting, where the price paid by the advertiser depends on the size and the composition of the audience. For example, an advertisement for skis may cost more to appear in a skiing magazine than a daily newspaper in Sri Lanka. Further, an advertisement appearing in a skiing magazine with a higher circulation may be more valuable than an advertisement in a skiing magazine with lower circulation. A larger, targeted audience may be more likely to actually buy the product or service being advertised.

Until the advent of electronic commerce, actually measuring how effectively a particular advertisement converted audiences was difficult. Two solutions to this problem were coupons and promotional deals that offer a discount for mentioning the advertisement. With online advertising, an advertisement may measure whether a user acted on the advertisement by selecting a hypertext link to a commercial website in the advertisement, referred to as “click through.” Further, when a purchase is made online, the advertisement may measure the proportion of users shown the advertisement that actually completed a purchase. These features have led to the emergence of pay-per-click and even pay-per-purchase advertising. These pay-per-action advertisements may typically provide the user with a browser cookie to count the number of users who get from the advertisement exposure to the instrumented page. A browser cookie is a hypertext transfer protocol (HTTP) text string stored by a user's web browser. The instrumented page may be a secure transaction web page, such as a purchase confirmation page or signup confirmation page.

For example, an advertising platform may load an advertisement while placing a browser cookie on a user's machine. The user may later visit a client page that includes a transparent graphics interchange format (GIF) link or Javascript® specified by the advertising platform on the conversion page. In the case of a transparent GIF link, the GIF object may be located on a universal resource locator (URL) on an advertising server of the advertising platform. When the client page loads, the user's machine may load the GIF object from the advertising server, whereupon the advertising server may read the browser cookie from the user's machine to register a conversion corresponding to the initial ad impression. In the case of Javascript®, the Javascript® may contact the advertising server to achieve the same end result.

The state-of-the-art in online advertising may be a display ad, a contextual ad, or a search advertisement that may be paid for on a per-impression, selection, or action basis. A display advertisement is a banner advertisement or other type of advertisement with a visual display. A contextual advertisement is a text advertisement embedded into a related content page. A search advertisement is an advertisement that is returned in response to a search. In many cases, the advertisement delivery and user action occur online. However, a large portion of goods and services may be delivered and purchased offline, in the physical world.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a physical world tracking mechanism that monitors the efficacy of an advertisement with an offline conversion component. In one embodiment, a data storage device stores a commercial location described in the advertisement and associates a conversion action with the advertisement. A processor registers the conversion action at the commercial location executed by a handheld computing device of a user.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, of a communication system.

FIG. 2 illustrates, in a block diagram, of an exemplary computing device.

FIG. 3 illustrates, in a block diagram, one embodiment of a handheld computing device.

FIG. 4 illustrates, in a block diagram, one embodiment of a set of components that may be integrated with a handheld computing device.

FIG. 5 illustrates, in a block diagram, one embodiment of a storefront acting as a commercial location.

FIG. 6 illustrates, in a block diagram, one embodiment of a virtual coupon associated with an online advertisement.

FIG. 7 illustrates, in a flowchart, one embodiment of a method using a handheld computing device to select or view an online advertisement.

FIG. 8 illustrates, in a flowchart, one embodiment of a method for displaying an online advertisement with an advertisement server.

FIG. 9 illustrates, in a block diagram, one embodiment of a user profile.

FIG. 10 illustrates, in a block diagram, one embodiment of an advertisement profile.

FIG. 11 illustrates, in a flowchart, one embodiment of a method of executing a conversion action with a handheld computing device.

FIG. 12 illustrates, in a flowchart, one embodiment of a method of registering a conversion action with an advertisement server.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a conversion tracking system for a computing device.

A user may see an advertisement in the offline “physical world” or in an online “virtual world”. The advertisement may be commissioned by a promoter to get the user to come perform a conversion action at a commercial location. A promoter is a seller, a vendor, an event coordinator, or other person trying to influence a user action regarding a commercial location based on the advertisement. A commercial location is a location of interest for the user that is maintained by the promoter. The commercial location is the setting for a commercial event, such as a sale, a social event, or other events that may benefit from advertising. The promoter may not necessarily be the owner of the commercial location. A conversion action is any action taken by the user at the commercial location that indicates a reaction to an advertisement, not necessarily a purchase. A conversion action may be as simple as entering the commercial location with a handheld computing device.

An advertising service is a service that provides commercial information to the user in order to get that user to go to the commercial location and perform a conversion action. The advertising service may use an advertisement server to direct that commercial information over the internet. The advertising service may also provide that information in an offline setting and track the offline advertising using the advertisement server.

The efficacy of an advertisement may be measured in different ways, depending on the type of advertisement. For an online advertisement, each user that views the online advertisement may be registered, through capture of a browser cookie, internet protocol (IP) address capture, and other methods. The user may view the online advertisement on a handheld computing device or on a different computing device associated with a user profile of that user. The commercial location associated with that advertisement may then be periodically compared with the user location, as registered using a variety of methods. If the user approaches the commercial location, depending on the metrics being used to charge for that advertisement, the online advertisement may be considered successful.

The possession of a handheld computing device by the user may provide numerous ways of tracking a user location. The handheld computing device may use a positioning service to determine its location, such as a geographical positioning system (GPS) or cell-tower triangulation. A GPS uses a system of geostationary satellites to triangulate the position of a terrestrial object. A terrestrial receiver that is capable of maintaining contact with at least three satellites may use the timing of the signals to determine its position. A GPS receiver may be tracked to within tens of feet, which may verify that a user is in or next to a small store.

Cell-tower triangulation has an accuracy of a few hundred feet, which can be used to verify if a user is on the same block as a store. Cell-tower triangulation determines the location of a cellular device by measuring the receiving time between the cellular device and three or more known cell-tower locations. Since the speed of the transmissions is known, the distance from these locations may be calculated, with the three distances from three distinct known locations combined to create a definitive location.

A wireless local area network (WLAN) may provide a location with accuracy for indoor locations greater than GPS and cell-tower triangulation. The WLAN may have a limited range. Therefore, a handheld computing device that connects to a WLAN may be within a limited range. Tracking a handheld computing device through WLAN localization may be more effective for indoor locations than GPS and cell-tower triangulation. An advertisement server that is accessed via the internet may register the WLAN that the handheld computing device used to access the internet.

Using some or a combination of these location sensing modalities, an advertisement server or a handheld computing device may track when a user visits a commercial location. In certain applications, where the promoter desires to increase traffic at a mall or a Starbucks, mere presence may be sufficient for conversion tracking.

For offline advertising, tracking whether a user has viewed the advertisement may be more difficult. By causing the user to execute a more active conversion action, referred to as an explicit handshake, an advertising service may track whether the advertisement was successful. An explicit handshake is an action the user or the promoter at a commercial location explicitly takes to signify that a conversion has taken place. For example, a user may scan a barcode or tag at the commercial location to claim loyalty points or credits and so signify to the platform that the user is at that location. The promoter may scan a coupon presented by the user or enter a coupon code into a website in order to signify to the platform that a purchase took place

Confirmation of the conversion may help deter underreporting by promoters and users. A promoter may underreport conversions if the promoter pays on a per-conversion basis. A user may under-report simply because the user has no incentive to report. Underreporting may be mitigated by using location-based conversion tracking in addition to handshakes, and by providing users with a user financial incentive to report conversions. These incentives may be credits, loyalty points, discounts, or other benefits to the user. Additionally, if the advertising service is associated with the data service used by the handheld computing device, the advertising service may offer discounts on that data service, subsidized by the promoter.

Confirmation may also help deter over-reporting of conversions by users. While a promoter is unlikely to over-report if the promoter pays per conversion, a user may over-report either to take advantage of reporting incentives or to harm the promoter. Over-reporting may be alleviated by requiring an explicit handshake with both the promoter and the user verifying that the transaction took place.

By tracking conversions in the offline setting, the advertising service may provide more efficient advertising to the promoter with a more targeted efficient approach. The advertising service may then charge the promoter a premium for higher quality service. Additionally, the advertising service may allow the promoter to take a more dynamic approach to the incentives offered to users. For example, the promoter may offer a dynamic coupon that offers a greater discount the earlier the user gets to a sale, making adjustments as more customers come to the sale. Additionally, a user may start to receive advertisements that are more germane to that user's wants and needs, and may receive less undesired advertisements, or “spam”.

Thus, in one embodiment, a physical world tracking mechanism may monitor the efficacy of an advertisement with an offline conversion component. A data storage device may store a commercial location associated with the advertisement and associate a conversion action with the advertisement. A processor may register the conversion action at the commercial location executed by a handheld computing device of a user.

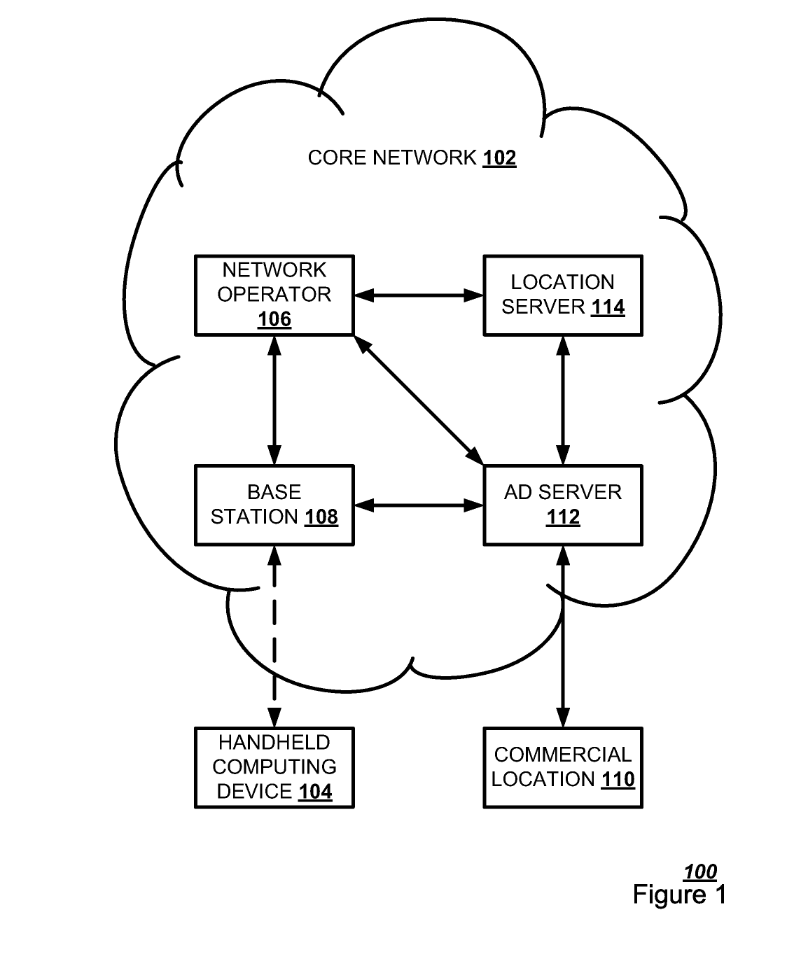

FIG. 1 illustrates one embodiment of a communication system 100 that may be used to implement the present invention. The communication system 100 may include a core network 102 that may be accessed by a handheld computing device 104. The handheld computing device 104 may also be referred to as subscriber units, mobiles, mobile stations, user, wireless communication devices, user devices, or by other terminology used in the art. Various communication devices may exchange data or information through the core network 102. The core network 102 may be a WiMAX network, a universal terrestrial radio access network (UTRAN) cellular network, an evolved UTRAN (E-UTRAN) cellular network, or other type of telecommunication network. A server or a series of servers controlled by a network operator, referred to herein as a network operator server 106, or a network operator 106, may administer the network. The network operator server 106 may maintain a set of data to facilitate access of the core network 102 by the handheld computing device 104. The handheld computing device 104 may access the network via a base station 108. A base station 108 may also be referred to as an access point, access terminal, base, base station, Node-B, eNode-B, Home Node-B, Home eNode-B, relay node, or by other terminology used in the art.

A user operating the handheld computing device 104 may use the core network 102 to access the internet to search for a commercial location 110. A commercial location 110 may be a storefront, a festival site, a stadium, an auditorium, a public square, a public park, or other site of commercial events. The commercial location 110 may execute a contract for advertising with an advertising service hosted by an advertisement server 112. An advertisement server 112 administers charging any advertisement fees to the commercial location 110 for the advertising service. The advertisement server 112 may provide advertisements promoting a commercial location to a variety of platforms on the core network 102. The platforms may be a website, an addition to a text message or an email message, or other network medium.

Each of the mobile aspects of the core network 102 may be monitored by a location server 114. The location server 114 may maintain a database of static locations, such as the commercial location 110. The location server 114 may then maintain a correlation between the static locations and a mobile location, such as the location of the handheld computing device 104 in relation to the commercial location 110. Generally, a core network 102 may use the location server 114 to determine the location of any mobile components of the core network 102. To protect the privacy of the user, the advertisement server 112 may have to seek the consent of the user before seeking access to any of the user's location data stored in the location server 114.

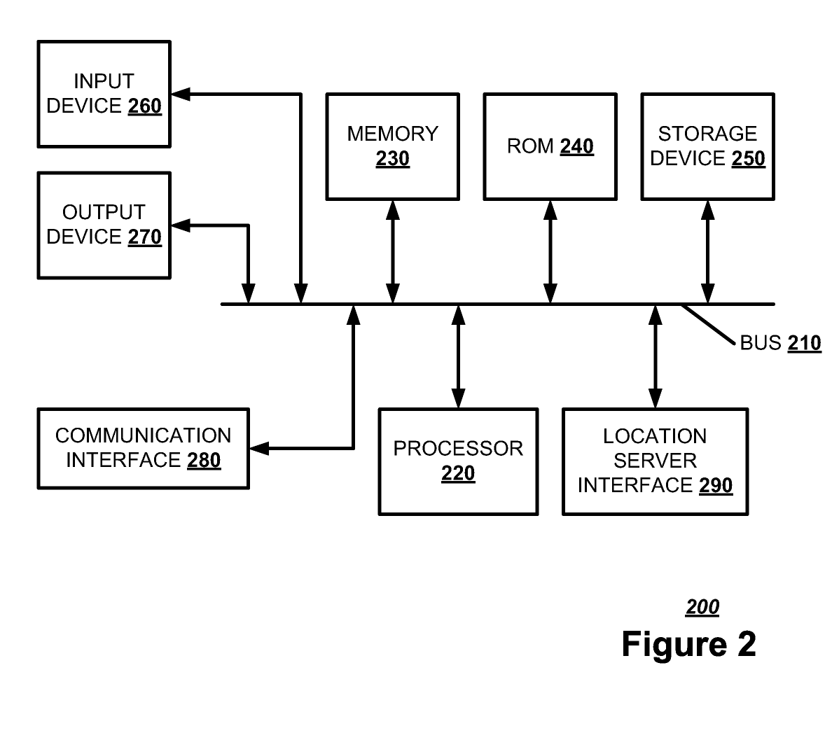

FIG. 2 illustrates a block diagram of an exemplary computing device 200 which may act as an advertisement server 112, a location server 114, a base station 108, or a network operator 106. The computing device 200 may include a bus 210, a processor 220, a memory 230, a read only memory (ROM) 240, a data storage device 250, an input device 260, an output device 270, a communication interface 280, and a location server interface 290. The bus 210 may permit communication among the components of the computing device 200.

The processor 220 may include at least one conventional processor or microprocessor that interprets and executes a set of instructions. The memory 230 may be a random access memory (RAM) or another type of dynamic storage device that stores information and instructions for execution by the processor 220. The memory 230 may also store temporary variables or other intermediate information used during execution of instructions by the processor 220. The ROM 240 may include a conventional ROM device or another type of static storage device that stores static information and instructions for the processor 220. The storage device 250 may include any type of tangible machine-readable medium, such as, for example, magnetic or optical recording media and its corresponding drive. The storage device 250 may store a set of instructions detailing a method that when executed by one or more processors cause the one or more processors to perform the method. The storage device 250 may also be a database or a database interface for storing the tracking infrastructure data, such as the asset management database.

The input device 260 may include one or more conventional mechanisms that permit a user to input information to the computing device 200, such as a keyboard, a mouse, a voice recognition device, a microphone, a headset, etc. The output device 270 may include one or more conventional mechanisms that output information to the user, including a display, a printer, one or more speakers, a headset, or a medium, such as a memory, or a magnetic or optical disk and a corresponding disk drive. The communication interface 280 may include any transceiver-like mechanism that enables processing device 200 to communicate with other devices or networks. The communication interface 280 may include a network interface or a mobile transceiver interface. The communication interface 280 may be a wireless, wired, or optical interface. In one embodiment, the communication interface 280 may include a universal serial bus (USB) interface, a Bluetooth® interface, or other such interface that may be used to attach peripheral devices. The computing device 200 may have a dedicated location server interface 290 to directly interact with the location server 114. Alternately, the communication interface 280 may act as a location server interface 290.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the storage device 250, or from a separate device via the communication interface 280.

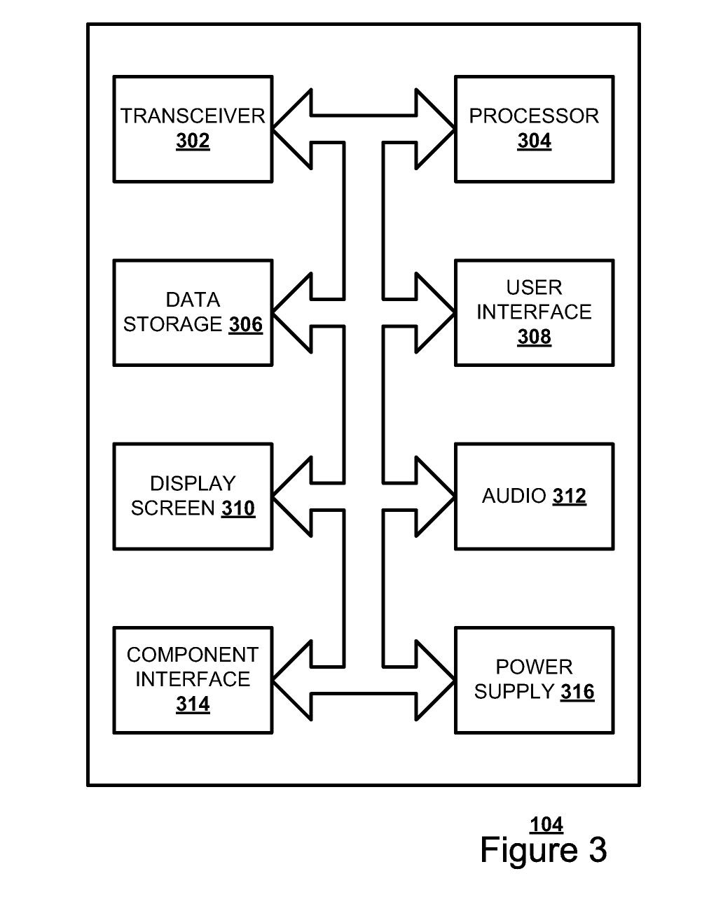

FIG. 3 illustrates one embodiment of a handheld computing device 104. The handheld computing device 104 may also support one or more applications for performing various communications with a network. The handheld computing device 104 may be a handheld device, such as, a mobile phone, a laptop, or a personal digital assistant (PDA). The user device 104 may be a WiFi® capable device, which may be used to access the core network 102 for data.

The handheld computing device 104 may include a transceiver 302, which is capable of sending and receiving data over the core network 102. The handheld computing device 104 may include a processor 304 that executes stored programs. The handheld computing device 104 may also include a volatile memory and a non-volatile memory to act as data storage 306 for the processor 304. The handheld computing device 104 may include a user input interface 308 that may comprise elements such as a keypad, touch screen, and other input devices. The handheld computing device 104 may also include a user output device that may comprise a display screen 310 and an audio interface 312 that may comprise elements such as a microphone, earphone, and speaker. The handheld computing device 104 also may include a component interface 314 to which additional elements may be attached. Finally, the handheld computing device 104 may include a power supply 316.

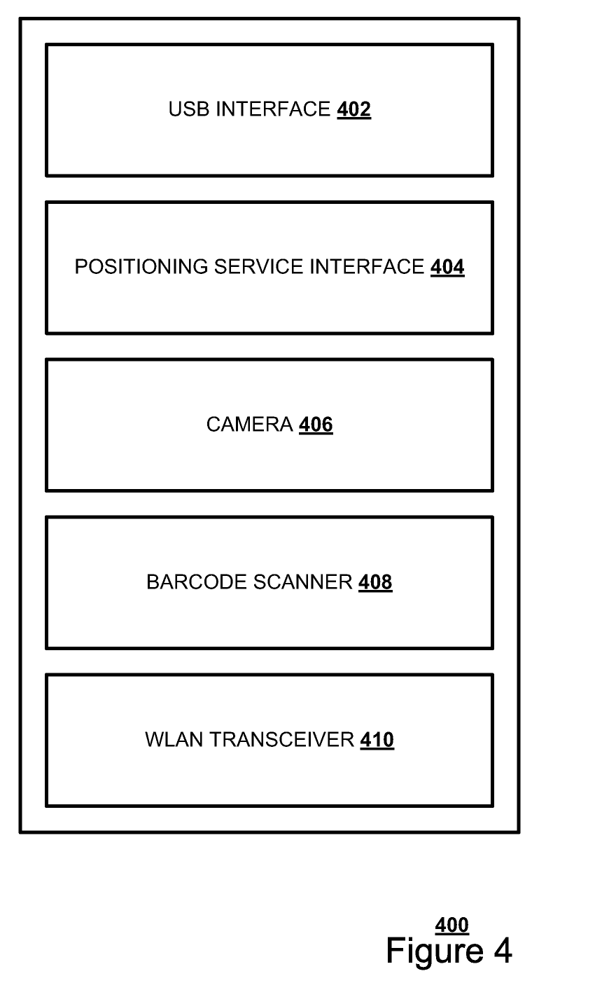

FIG. 4 illustrates, in a block diagram, one embodiment of a set 400 of components that may be integrated with a handheld computing device 104 via the component interface 314. The handheld computing device 104 may have a USB interface 402 that may allow for peripheral objects to be connected to the handheld computing device 104. The handheld computing device 104 may have a positioning service interface 404, such as a GPS receiver or dedicated processor for cell-tower triangulation to pinpoint the exact location of the handheld computing device 104. The handheld computing device 104 may have a digital camera 406 to capture digital images, which may be stored in the data storage 306.

The handheld computing device 104 may have a barcode scanner 408 to read barcode data. A barcode is an identification label that may be optically recognized by a mechanical device, generally applied to a sale product. While originally a barcode referred to a series of black bars, the common definition of a barcode has expanded to mean any machine-readable series of markings used for identification purposes, regardless of whether those markings are bar shaped.

Additionally, the handheld computing device 104 may have a dedicated wireless local area network (WLAN) transceiver 410, or WiFi® transceiver, in addition to a standard transceiver 302. The WLAN is a local network that may be accessed by a computing device via a wireless router. The WLAN may often be established at a commercial location 110 for use by employees or customers. The computing device may then use the WLAN to access the internet.

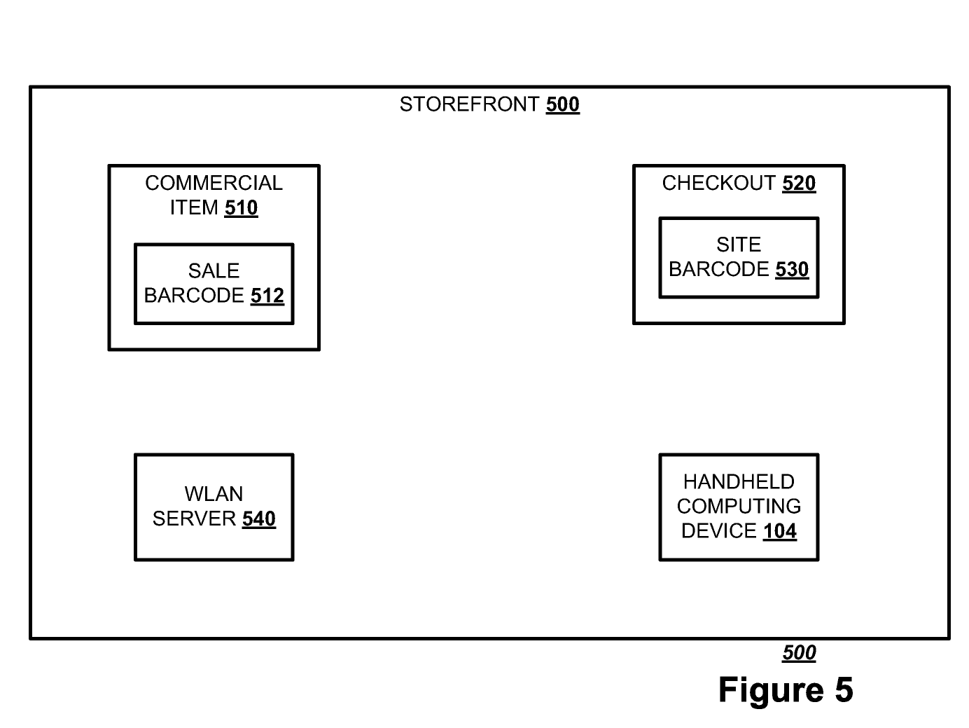

FIG. 5 illustrates, in a block diagram, one embodiment of a storefront 500 acting as a commercial location 110. A storefront 500 is any commercial location 110 that has tangible commercial items 510 being sold on site. The storefront 500 may perform other functions in addition to selling sales items, such as being a performance site. The commercial items 510 may be perishables, such as food items, that may be consumed on premises. A commercial item 510 may have a sale barcode 512 identifying the commercial item 510 when scanned. The storefront 500 may have a checkout location 520 where the commercial item 510 may be purchased.

The storefront 500 may have a site barcode 530 that identifies the storefront 500 when scanned by a barcode scanner 408 of the handheld computing device 104. The handheld computing device 104 may then send this identification to the advertisement server 112. The site barcode 530 may be located at the checkout location 520 or at other locations in the storefront 500.

The storefront 500 may have WLAN server 540 to maintain a WLAN. The handheld computing device 104 may access the WLAN by connecting with the WLAN server 540 with the transceiver 302 or the WLAN transceiver 410, allowing the handheld computing device 104 to more easily access the internet for information regarding the storefront 500 or the commercial items 510. The advertisement server 112 may use this access as evidence to locate the handheld computing device 104 at the commercial location 110.

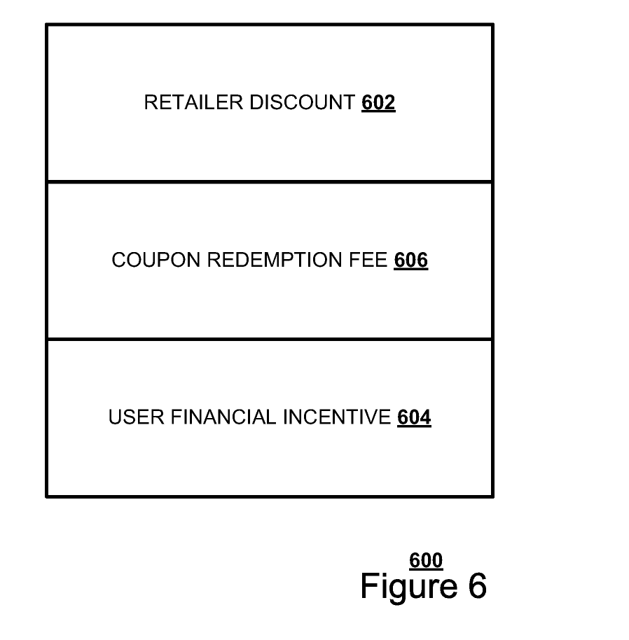

FIG. 6 illustrates, in a block diagram, one embodiment of a virtual coupon 600 associated with an online advertisement provided by the advertisement server 112. The promoter of the commercial location 110 may hire the advertising service executed by the advertisement server 112 to provide online advertisement for the commercial location 110. The online advertisement may be a virtual coupon 600 for the commercial location 110. The virtual coupon 600 may have multiple components. The virtual coupon 600 may have a deferred payment component, such as a retailer discount 602 that discounts the cost of a commercial item 510 to entice a customer into the commercial location 110. The retailer discount 602 may be tied to a specific item, or may be a general percentage discount for any set of one or more items purchased at the commercial location 110. The coupon 600 may have a dynamic value for the retailer discount 602 based on a prior sales figure. For example, the coupon 600 may give the user a 20% discount on any items purchased if the user is one of the first 100 purchasers, then provide a 10% discount if the user is a purchaser thereafter.

Further, the virtual coupon 600 may have a direct payment component, such as a user financial incentive 604 or a coupon redemption fee 606. The user financial incentive 604 is generally a monetary incentive to perform the conversion action, either paid directly to the user or purchasing a good or service on the user's behalf. The user financial incentive 604 may be a data service fee. The data service fee may be a payment by the promoter of the commercial location to a data service provider for the handheld computing device 104, in order to discount the cost of the data service plan subscribed to by the user as an enticement for the user of the handheld computing device to come perform a conversion action at the commercial location 110. Additionally, the user financial incentive 604 may entice the user of the handheld computing device to report the conversion action to the data service provider, and thus to the advertising service. The coupon redemption fee 606 is a payment from the promoter to the advertising service for completion of a successful conversion.

The user may receive an online advertisement via a handheld computing device 104 while in the vicinity of the commercial location 110. Alternatively, the user may see the online advertisement earlier on a more stationary computing device. The advertising service may maintain a profile of the user, so as to track what advertisements have been shown to the user. The user may see the advertisement in a physical world setting, such as a billboard or a television or radio advertisement. The advertising service may determine that a user has seen these advertisements by associating the advertisement with a commercial impression action to indicate viewing of the advertisement. The advertising service may determine that a user has seen these advertisements by associating them with a conversion action. Alternately, the advertising service may determine that the user has been near an advertisement site, such as a billboard, close in time to the user entering the commercial location 110. The advertisement site may be fitted with a transmitter to alert the handheld computing device 104 that the user has been near an advertisement site. The conversion action may include a series of actions starting with a commercial impression action indicating that the user has seen the advertisement followed by a commercial response action indicating that the user has responded to the advertisement.

The handheld computing device 104 may preserve privacy and reduce interruptions to the user when interacting with the advertisement server 112 by relying on an opt-in system, or awaiting a search by the user. Alternately, the advertisement server 112 may preserve privacy by downloading a set of advertisements targeted to user preferences to the handheld computing device 104. The handheld computing device 104 may then filter the set of targeted advertising to focus on advertising local to the handheld computing device 104.

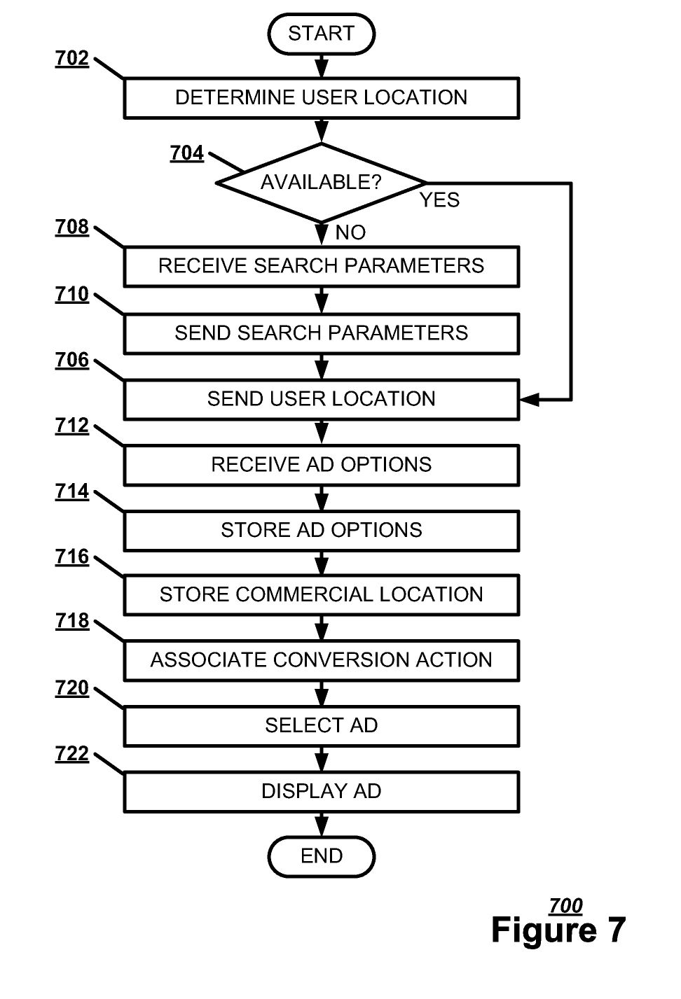

FIG. 7 illustrates, in a flowchart, one embodiment of a method 700 for using a handheld computing device to select or view an online advertisement. The handheld computing device 104 may determine the user location, either by using a positioning service, such as a GPS receiver or cell-tower triangulation, or by accessing the WLAN (Block 702). If the user has set a user status indicating availability to locally targeted advertising (Block 704), the handheld computing device 104 may send the user location to the advertisement server 112 (Block 706). Locally targeted advertising is advertising sent to a user based on a user location. Locally targeted advertising may also take into account other factors such as time of day and previously indicated user preferences.

If the user has set a status indicating no availability to locally targeted advertising (Block 704), the handheld computing device 104 may wait to receive a query revealing a set of one or more search parameters from the user via the user interface 308 (Block 708). The handheld computing device 104 may send the search parameters to the advertisement server 112 via the core network 102 (Block 710). The handheld computing device 104 may then send the user location to the advertisement server 112 (Block 706). The handheld computing device 104 may receive a set of one or more advertisement options from the advertisement server 112 in response to the search parameters and the user location (Block 712). The handheld computing device 104 may store the advertisement options in the data storage 306 (Block 714). For each advertisement option, the handheld computing device 104 may store a commercial location associated with that advertisement option (Block 716). For each advertisement option, the handheld computing device 104 may associate a conversion action with that advertisement option (Block 718). The handheld computing device 104 may select an advertisement for the user from the advertisement options based on the user location and the search parameters (Block 720). The handheld computing device 104 may display the selected advertisement options to the user via the display screen 310 (Block 722). The user may make a decision based on these advertisements or may select one of the advertisement options to receive more information.

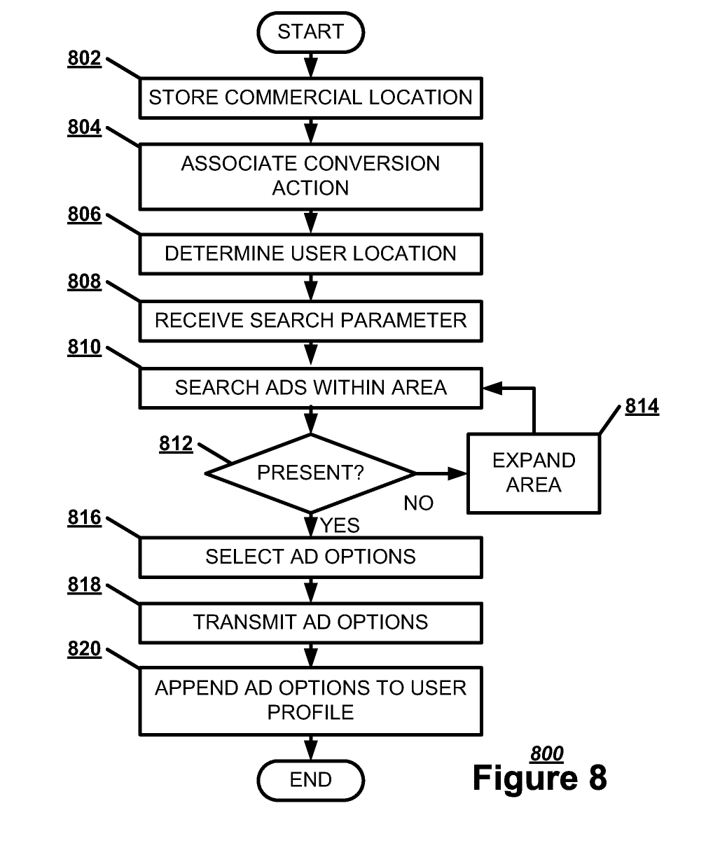

FIG. 8 illustrates, in a flowchart, one embodiment of a method 800 for displaying an advertisement with an advertisement server 112. The advertisement server 112 may store the commercial location 110 described in the advertisement (Block 802). The advertisement server 112 may associate an advertisement with a conversion action to be performed at a commercial location 110 (Block 804). The advertisement server 112 may determine a geographic location for the user via the handheld computing device 104, either receiving a user location directly from the handheld computing device 104 or from the location server 114, if consented to by the user (Block 806). The advertisement server 112 may receive one or more search parameters for a commercial item by the user from the handheld computing device 104 (Block 808). The advertisement server 112 may then search for advertisements within a location area of the user location based on the search parameters (Block 810). If an appropriate advertisement is not within the location area (Block 812), the advertisement server 112 may expand the location area (Block 814). Once one or more suitable advertisements are found within the location area (Block 812), the advertisement server 112 may select one or more advertisement options for the handheld computing device 104 (Block 816). The advertisement server 112 may then transmit the one or more advertisement options to the handheld computing device 104 (Block 818). The advertisement server 112 may append the selected advertisement options to the user profile to monitor the user's interactions with the commercial locations of the advertisements (Block 820).

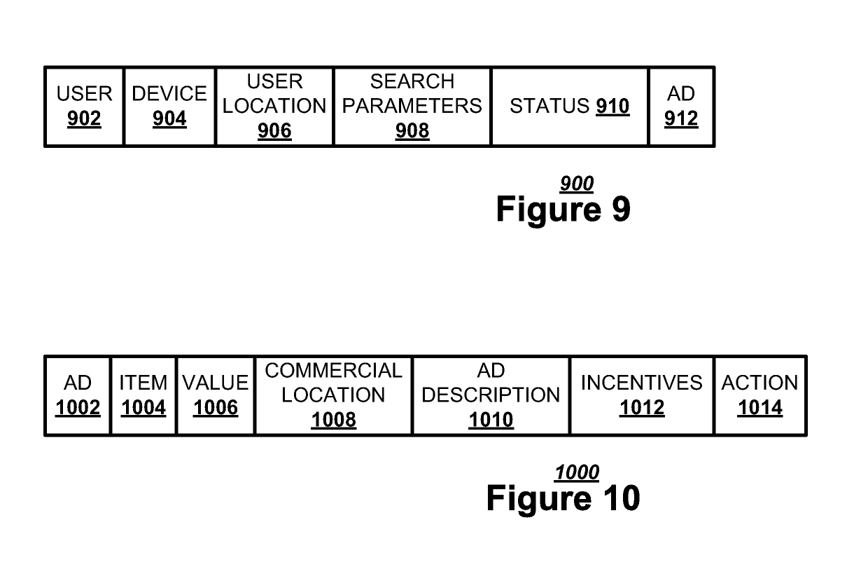

FIG. 9 illustrates, in a block diagram, one embodiment of a user profile 900. The user profile 900 may have a user identification (ID) 902, to allow the user to be tracked across multiple hardware devices. The user profile 900 may have a device ID 904 to connect the handheld computing device 104 to the user. The user profile 900 may have a general user location 906 indicating a general location last searched by the user, the most recent search parameters 908 submitted by the user, and the status level 910 for that user. The status level 910 indicates if the user is open to receiving unsolicited locally targeted advertising. The user profile 900 may have a link 912 to one or more advertisements profiles visited by the user, so that the advertisement server 112 may track the effectiveness of the advertisements on the user.

FIG. 10 illustrates, in a block diagram, one embodiment of an advertisement profile 1000. The advertisement profile 1000 may have an advertisement ID 1002 identifying the advertisement being profiled. The advertisement profile may have an item ID 1004, indicating any items described in the advertisement. The advertisement profile 1000 may have a value field 1006 to describe the value of any discounts offered in the advertisement. The advertisement profile 1000 may have a commercial location field 1008 indicating the commercial location 110 associated with the advertisement. The advertisement profile 1000 may have an advertisement description field 1010 that gives keywords and parameters associated with the advertisement, to allow the advertisement to be more easily matched with a search by a user. The advertisement profile 1000 may have an incentives field 1012 to indicate any user financial incentives offered in the advertisement, such as a discount on the data service for the handheld computing device 104 or any other incentives unrelated to the commercial item. The advertisement profile 1000 may have an action field 1014 describing the conversion action to indicate effectiveness of the advertisement.

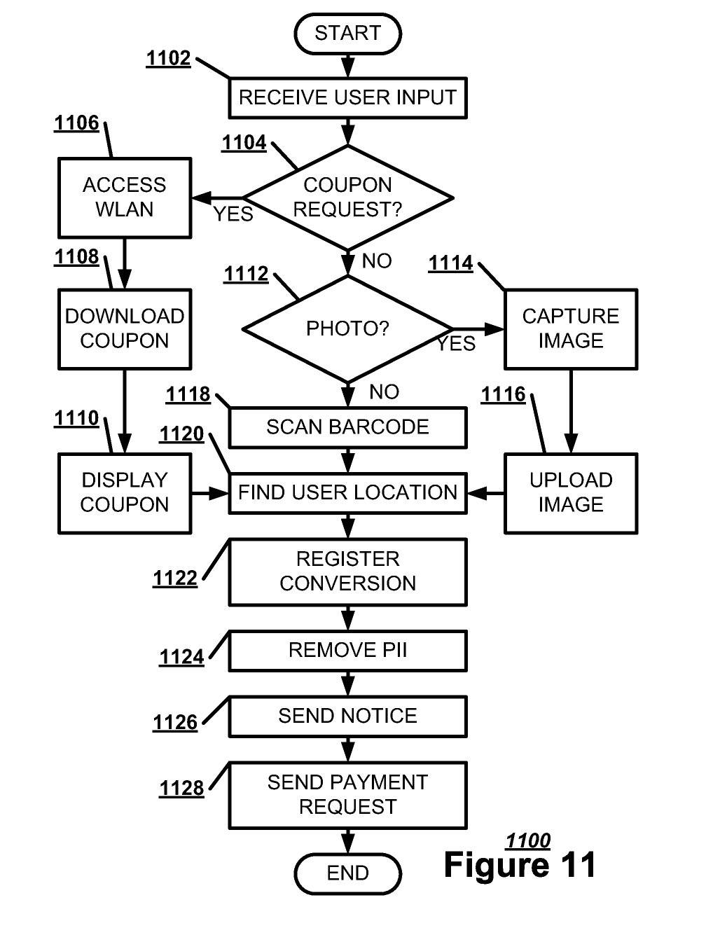

FIG. 11 illustrates, in a flowchart, one embodiment of a method 1100 of executing a conversion action with a handheld computing device. The handheld computing device 104 may receive a user input initiating a conversion action (Block 1102). If the user requests an online coupon (Block 1104), the handheld computing device 104 may access the WLAN of the commercial location 110 (Block 1106). The handheld computing device 104 may then download an online coupon for the conversion action at the commercial location from the advertisement server (Block 1108). The handheld computing device 104 may then display the online coupon to the promoter of the commercial location 110 for scanning (Block 1110). If the user wants to take a digital photo of a location specific image, such as a significant item featured in the advertisement (Block 1112), the handheld computing device 104 may capture a digital image of the location specific image with the digital camera 406 (Block 1114). The handheld computing device 104 may upload the digital image to the advertisement server 112 (Block 1116). Alternately, the user may upload the digital image from the handheld computing device 104 to a personal website listed in the user profile 900 as specified by the advertisement. The personal website may be a profile site on a social networking site, such as Facebook®, Twitter®, or other social networking sites. If the user input indicates that a site barcode 530 or an item barcode 512 is to be scanned (Block 1112), then the handheld computing device 104 may scan the barcode data using the barcode scanner 408 or photograph the barcode data using the digital camera 406 (Block 1118). The handheld computing device 104 may then determine the user location, either by using a positioning service, such as a GPS receiver or cell-tower triangulation, or by accessing the WLAN (Block 1120).

Upon completion of a conversion action associated with the advertisement at the commercial location of the advertisement, the handheld computing device 104 may register the conversion action at the commercial location (Block 1122). The handheld computing device 104 may remove any personally identifiable information (PII) from the evidence of the conversion action (Block 1124). The handheld computing device 104 may then notify the advertisement server 112 of the conversion action, providing evidence of the conversion action (Block 1126). The notice of the conversion action may cause the advertisement server 112 to automatically charge an advertisement fee to a promoter associated with the commercial location 110. The handheld computing device 104 may send a payment request to a disbursement system for any user financial incentives included in the advertisement (Block 1128).

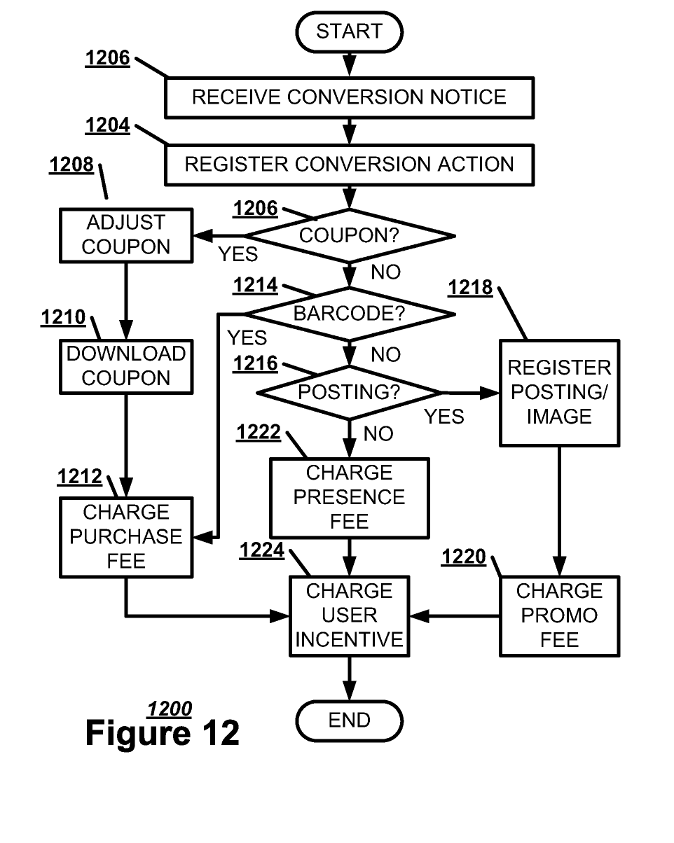

FIG. 12 illustrates, in a flowchart, one embodiment of a method 1200 of using an advertisement server 112 to register a conversion action at the commercial location executed by a handheld computing device 104 of a user. While the method 1200 is described as being executed by the advertisement server 112, the handheld computing device 104 may also execute the method 1200 and report to the advertisement server 112 upon its completion. The advertisement server 112 may receive notice of a conversion action from the handheld computing device 104 (Block 1202). The notice may have evidence of the conversion action. The advertisement server 112 may register the conversion action executed by the handheld computing device 104 (Block 1204).

The advertisement server 112 may automatically charge an advertisement fee to a promoter associated with the commercial location upon notice of the conversion action. The advertisement server 112 may adjust the advertisement fee based upon the conversion action performed. If the conversion action is a request for a coupon for the conversion action at the commercial location 110 (Block 1206), the advertisement server 112 may adjust the dynamic value of the coupon based on a prior sales figure, a user profile 900, or the activities of other consumers in the region (Block 1208). The advertisement server 112 may download the coupon to the handheld computing device 104 (Block 1210). The advertisement server 112 may charge the promoter a purchase fee, as the user has presumably purchased a good or service from the promoter (Block 1212). Alternately, the user may purchase an item or a service without using a coupon. The user may still prove that purchase by using the handheld computing device 104 to visually capture a purchase item specific image, such as scanning a barcode, and uploading the purchase item specific image to the advertisement server 112. If the advertisement server 112 receives a purchase item specific image, such as a scanned barcode (Block 1214), the handheld computing device 104 may charge the promoter a purchase fee (Block 1212).

The conversion action may be an online posting proving the user was present in the store, such as an online review or a location specific image visually captured by a handheld computing device 104 posted to a website. The advertisement server 112 may receive the location specific image directly from the handheld computing device 104 or a link to the online posting. If the advertisement server 112 receives a link to an online posting (Block 1216), the advertisement server 112 may register that the online posting has been posted to a website (Block 1218). The advertisement server 112 may charge the promoter a promotional fee, as the user has promoted a good or service for that commercial location (Block 1220).

The conversion action may be the presence of the user in the commercial location 110. Particularly, the promoter may be seeking to gather a crowd at a commercial location 110 for an event or to make a store look busy. The advertisement server 112 may charge the promoter a presence fee, as the performance of a conversion action by the handheld computing device 104 in the commercial location 110 has shown that the user has at least entered the store (Block 1222). The advertisement server 112 may then generate a user financial incentive 604 automatically charged to the promoter associated with the commercial location 110 upon notice of the conversion action to reward the user for performing the conversion action (Block 1224).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method for tracking an advertisement in the physical world, comprising:
storing a commercial location associated with an advertisement;
associating a conversion action with the advertisement; and
registering the conversion action at the commercial location with a handheld computing device of a user.

2. The method of claim 1, wherein the advertisement is displayed on the handheld computing device.

3. The method of claim 1, further comprising:
determining a user location for the user via the handheld computing device; and
selecting the advertisement for the user based on the user location.

4. The method of claim 1, further comprising:
receiving a search parameter for a commercial item from the user; and
selecting the advertisement for the user based on the search parameter.

5. The method of claim 1, wherein the advertisement is a coupon with a dynamic value.

6. The method of claim 1, further comprising:
determining that the user is at the commercial location by using a positioning service of the handheld computing device.

7. The method of claim 1, further comprising:
determining that the user is at the commercial location upon access by the handheld computing device to a wireless local area network.

8. The method of claim 1, further comprising:
uploading a location specific image visually captured by the handheld computing device.

9. The method of claim 1, further comprising:
downloading a coupon to the handheld computing device for the conversion action at the commercial location.

10. The method of claim 1, wherein a promoter associated with the commercial location is automatically charged an advertisement fee upon notice of the conversion action.

11. The method of claim 1, wherein a promoter associated with the commercial location is automatically charged a user financial incentive upon notice of the conversion action.

12. A tangible machine-readable medium having a set of instructions detailing a method stored thereon that when executed by one or more processors cause the one or more processors to perform the method, the method comprising:
storing a commercial location associated with an advertisement;
associating a conversion action with the advertisement;
registering the conversion action at the commercial location executed by a handheld computing device of a user; and
notifying an advertisement server of the conversion action to cause the advertisement server to automatically charge an advertisement fee to a promoter associated with the commercial location.

13. The tangible machine-readable medium of claim 12, wherein the advertisement fee is adjusted based upon the conversion action performed.

14. The tangible machine-readable medium of claim 12, wherein the method further comprises:
determining a user location for the user via the handheld computing device; and
selecting the advertisement for the handheld computing device based on the user location.

15. The tangible machine-readable medium of claim 12, wherein the method further comprises:
receiving a search parameter for a commercial item; and
selecting the advertisement to the handheld computing device based on the search parameter.

16. The tangible machine-readable medium of claim 12, wherein the method further comprises:
determining that the user is at the commercial location by using a positioning service of the handheld computing device.

17. The tangible machine-readable medium of claim 12, wherein the method further comprises:
determining that the user is at the commercial location upon access by the handheld computing device to a wireless local area network.

18. The tangible machine-readable medium of claim 12, wherein the method further comprises:
uploading a location specific image visually captured by the handheld computing device posted to a website.

19. A physical world tracking mechanism of an advertisement, comprising:
a data storage that stores a commercial location associated with the advertisement and associates a conversion action with the advertisement;
a positioning service interface that determines a user location for a handheld computing device of a user;
a processor that selects the advertisement for display and registers the conversion action at the commercial location executed by the handheld computing device; and
a communication interface that notifies an advertisement server of the conversion action to cause the advertisement server to automatically charge an advertisement fee to a promoter associated with the commercial location.

20. The physical world tracking mechanism of claim 19, wherein the positioning service interface determines that the user is at the commercial location according to the handheld computing device.
